(19) United States
(12) Patent Application Publication
(10) Pub. No.: US 2006/0092758 A1
(43) Pub. Date: May 4, 2006

(54) Fluid mixing venturi

(76) Inventor: Peter Holmes Ellmers, Auckland (NZ)

Correspondence Address: YOUNG & THOMPSON, 745 SOUTH 23RD STREET, 2ND FLOOR, ARLINGTON, VA, 22202, US

(21) Appl. No.: 10/520,116

(22) PCT Filed: Jul. 2, 2003
(86) PCT No.: PCT/NZ03/00137

§ 371 Date: Sep. 23, 2005

(30) Foreign Application Priority Data
Jul. 3, 2002 (NZ) 516429

(51) Int. Cl. B01F 5/04

(52) U.S. Cl. 366/163.2

(57) ABSTRACT

A fluid mixing venturi (1) comprises; a venturi barrel (2), a constriction region (4) inside the venturi barrel (2), a fluid outlet nozzle (6) located by a nozzle location device (10) at a central region in the venturi barrel (2) for discharging a fluid into a fluid flowing through the venturi barrel (2), and a booster tube (8) located by a booster tube location device (14) so as to surround a fluid flowing from the nozzle (6).

### TECHNICAL FIELD

The present invention relates to fluid mixing venturi. For convenience only, the present invention will be predominantly described as a fluid mixing venturi for producing a low pressure and mixing fuel for an internal combustion engine, for which the invention may be particularly applicable. However, it is to be understood that the invention is not to be limited as such. Moreover, because the invention may have many other applications, the background art and possible applications of the invention discussed below are given by way of example only.

### BACKGROUND ART

A fluid mixing venturi such as used in an internal combustion engine generally comprises a constricted throat in the engine air intake passage for causing a reduction in pressure, whereby liquid fuel is drawn into the engine intake from a carburetor bowl in the case of a petrol engine, or fuel vapour is drawn in from a regulated gas supply in the case of an LPG or CNG engine. This reduction in pressure is referred to as a signal, and is proportional to the air flow rate through the engine intake. Generally, the higher the ratio of signal to flow rate the better the response of the engine to power demand (throttle opening), that is, tighter tuning control.

Moreover the reduction in pressure produced by the venturi is essential for producing mixing of the fuel with the intake air, the greater the reduction in pressure with flow rate, the greater the potential for atomization (in the case of liquid fuels) and mixing of the fuel with the air. With better atomization and mixing, more of the fuel is combusted and less fuel is wasted. Moreover emissions are improved.

Hence in designing a venturi for an internal combustion engine, a major aim is to optimize the signal to flow ratio, so as to have a minimum restriction to airflow capacity through the venturi (optimum flow rate) while achieving a maximum signal, that is signal to flow ratio.

One approach aimed in part at achieving this involves providing a booster ring concentrically in the throat of the venturi (refer to U.S. Pat. Nos. 5,809,972, and 6,305,461). This booster ring amplifies the suction signal of the main venturi found in the carburetor.

Various proposals have been made for the design and positioning of the booster ring, and in the disclosure of U.S. Pat. No. 5,809,972, it is noted that “in order to generate an even lower pressure in the air stream, than either the booster venturi ring or the venturi wall constriction would by themselves, the booster ring is positioned slightly upstream of the venturi wall constriction. As is known in the art, this lower pressure results in more complete atomization of the fuel in the airstream”.

While the above designs have been mainly directed towards gasoline fueled IC engines, similar requirements also apply to gas (CNG, LPG) fueled IC engines.

Moreover there is a need for a suitable fluid mixing venturi which can be manufactured at low cost and easily fitted to a gasoline fuel injection engine to enable a dual fuel engine, using both LPG or CNG and gasoline.

Furthermore, in other fields there is a demand for a fluid mixing venturi with a good signal to flow ratio, whereby a liquid or gas or a substance entrained therein, can be drawn into and mixed with a main flow.

Typical examples for such application may be in fire fighting where a flame retardant is mixed into a water flow, agricultural or cleaning spray devices where a chemical is mixed with a main fluid flow, or in fluidic systems (flow regulators etc.) where good signal to flow ratio is desired for control or the like.

### DISCLOSURE OF THE INVENTION

In view of the above, it is an object of the present invention to provide a fluid mixing venturi having a good signal to flow ratio for improved response, with good fluid mixing (atomization), or to at least provide the public with a useful choice.

According to a first aspect of the present invention there is provided a fluid mixing venturi comprising; a venturi barrel, a constriction region inside the venturi barrel, a fluid outlet nozzle located by a nozzle location device at a central region in the venturi barrel for discharging a fluid into a fluid flowing through the venturi barrel, and a booster tube located by a booster tube location device so as to surround a fluid flowing from the nozzle.

With such a construction, fluid flowing through the barrel of the venturi can be guided by the booster tube in the vicinity of the nozzle, to control flow conditions and give an increased pressure drop at the nozzle outlet depending on the relative location of the booster tube, outlet nozzle and constriction region. Hence suction signal can be improved.

Herein nozzle means an outlet through which a fluid (gaseous or liquid) is discharged under positive or negative pressure. A situation where this is discharged under positive pressure may be where the fluid mixing venturi is used only for mixing the fluid and not for producing a signal to control fluid discharge.

The central region may be any region away from the wall of the venturi barrel so that fluid can flow through and around the booster tube. It is generally envisioned however that the central region would substantially coincide with the central axis of the venturi barrel.

The nozzle location device may involve any suitable device whereby the nozzle can be located at the central region in the venturi barrel.

For example this may comprise a fluid (eg. fuel, fire retardant, chemical, secondary flow) supply tube to the nozzle mounted so as to extend downward from an inlet to the venturi (coaxial with the barrel), or mounted so as to extend out from a side wall of the venturi barrel and inclined or bent so as to extend downwards at the nozzle end.

In the case of the former arrangement, the fluid supply tube is aligned with the streamlines, and hence fluid resistance is minimal. In the latter case, since the fluid supply tube extends across the flow path, this may be formed in a streamlined (for example oval or rectangular) shape in cross-section, with a major axis aligned with the direction of flow, to reduce fluid resistance.

The booster tube location device may involve any suitable device whereby the booster tube can be located at a desired position in the venturi barrel. For example this may comprise one or more legs connected to a portion of the nozzle location device, or one or more legs connected between the booster tube and a wall of the venturi barrel.

In the case of the former arrangement, the axis of the leg or legs may be aligned with the streamlines, and hence fluid resistance is minimal. In the latter case, the leg or legs may be formed in a streamlined (for example oval or rectangular) shape in cross-section, with a major axis aligned with the direction of flow, to reduce fluid resistance.

The booster tube may be of any suitable size and shape in cross-section, as desired or required. Moreover, the location in the venture barrel with respect to the nozzle may be varied depending on design and performance requirements.

For example the booster tube may be of square of circular shape and arranged coaxial or non coaxial with the nozzle. However it is generally envisioned that this would be of circular shape and arranged coaxial.

The optimum location for the booster tube relative to the nozzle outlet may be determined by experiment or computation. Moreover, the optimum size (diameter or cross-section area) for the booster tube relative to the size (diameter or cross-section area) of the nozzle exterior or bore, may be determined by experiment or computation.

The construction may be such that the venturi barrel is of cylindrical shape, and the fluid outlet nozzle is provided substantially at the center thereof, and the booster tube is of an annular shape and is positioned coaxial with the venturi barrel in the vicinity of the nozzle so as to surround fluid flowing therefrom.

This arrangement may be suitable for a standard type engine intake venturi, for which the components are generally of cylindrical form.

The booster tube may be located so that at least a part thereof surrounds the nozzle outlet and a part surrounds the fluid flowing therefrom. Alternatively the booster tube may be located downstream of the nozzle outlet so as to only surround the fluid flowing therefrom.

An outlet rim of the booster tube may be formed with an outlet flow deflection device. Moreover, an inlet rim of the booster tube may be formed with an inlet flow deflection device.

By forming the flow deflection device at either or both the inlet rim and outlet rim of the booster tube, the mixing performance of the fluid mixing venturi may be improved.

The flow deflection device may comprise any device whereby the flow can be deflected to improve mixing, and/or in the case of an inlet flow deflection device, to enhance entrapment of the air into the booster tube.

For example the outlet rim flow deflection device and/or the inlet rim flow deflection device may be formed by flaring or chamfering the outlet rim or inlet rim outwards or inwards.

Moreover, the venturi barrel may also be formed with a flow deflection device. Such a flow deflection device is in addition to the aforementioned constriction region inside the venturi barrel.

By forming a flow deflection device on the venturi barrel, the flow through the barrel can be further altered to enhance flow conditions and improve the signal and mixing performance of the fluid mixing venturi.

The flow deflection device may comprise any device whereby the flow may be deflected. Moreover an optimum location of this in the venturi barrel may be determined by experiment. For example, this may comprise a recessed step in the wall of the venturi downstream of the constriction.

By providing a flow deflection device such as a recessed step downstream of the constriction, a turbulent flow can be produced to enhance fluid mixing. Moreover, this may serve to locate a transition region of the flow to ensure more accurate positional relationship between components and flow conditions. Furthermore, when combined with an outwardly flared outlet rim flow deflection device of the booster tube, this may serve to produce an annular outwardly expanding flow path, which may be beneficial depending on requirements.

With the above construction and configuration, the booster tube may be positioned in the venturi barrel with the inlet rim flush with or in the vicinity of the nozzle outlet.

Moreover, the booster tube may be positioned in the venturi barrel with the outlet rim in the vicinity of a plane containing the recessed step.

The fluid mixing venturi of the invention may be made from any suitable material. Moreover this may be made as separate components or molded in one integral unit.

A possible construction may involve moulding from plastics an upper and lower section for the venturi barrel, a fluid supply assembly including the nozzle, and a booster tube assembly including the booster tube location device. These four components can then be fitted together and welded to make up the complete assembly.

For the booster tube assembly, the booster tube location device may extend outwards from the booster tube, and the upper and lower sections may be separated at a suitable position to enable fitting of the booster tube assembly therebetween.

Moreover the upper section may be suitably adapted to accommodate the fluid supply assembly, when separated from the lower section.

With such an arrangement, the four components can be manufactured separately, thus enabling low cost manufacture. Moreover since, for example different upper and lower section can be used for the same booster tube assembly and/or fluid supply assembly, a versatile design is possible.

In assembling such a fluid mixing venturi, for example the fluid supply assembly can be fitted to the upper section, and the booster tube assembly fitted to the upper or lower sections. The upper and lower sections can then be fitted together and welded to make up a complete assembly. Of course other combinations are also possible.

According to another aspect of the present invention there is provided a method of increasing signal and improving fluid mixing/atomization of a fluid mixing venturi comprising; a venturi barrel, a constriction region inside the venturi barrel, and a fluid outlet nozzle located by a nozzle location device at a central region in the venturi barrel for discharging a fluid into a fluid flowing through the venturi barrel, the method involving: locating a booster tube so as to surround a fluid flowing from the nozzle.

In the above method, the location and configuration of the booster tube and the other components may be as described above for the fluid mixing venturi of the present invention.

The present invention may also broadly be said to consist in the parts, elements and features referred to or indicated in the specification of the application, individually or collectively, and any or all combinations of any two or more of the parts, elements or features, and where specific integers are mentioned herein which have known equivalents in the art to which this invention relates, such known equivalents are deemed to be incorporated herein as if individually set forth.

### BRIEF DESCRIPTION OF THE DRAWINGS

Further aspects of the present invention will become apparent from the ensuing description which is given by way of example only and with reference to the accompanying drawing in which;

FIG. 1A and FIG. 1B are schematic diagrams of a fluid mixing venturi according to an embodiment of the present invention, FIG. 1A being a side cross-section view and FIG. 1B being a top view.

FIG. 2 shows details of an alternative nozzle location device of the embodiment.

FIG. 3 shows details of nozzle location in relation to booster tube location and details of booster tube inlet and outlet flow deflection devices.

FIG. 4 shows details of a venturi bore flow deflection device, and a relation to the position and shape of the booster tube outlet flow deflection device.

FIG. 5 shows details of dimensions of the booster tube in relation to the venturi bore constriction.

FIG. 6 is a schematic diagram of the fluid mixing venturi of the embodiment used in a four barrel carburetor.

FIG. 7 is a perspective view of a fluid mixing venturi of an embodiment of the present invention illustrating a method of manufacture.

### BEST MODE FOR CARRYING OUT THE INVENTION

Embodiments of the present invention will now be described with reference to the figures.

These embodiments are applied to a fluid mixing venturi for supplying a fuel such as LPG or CNG to air flowing through a venturi barrel. Hence the fluid is referred to as fuel. However it will be understood that the embodiments are also applicable to supplying and mixing other fluids.

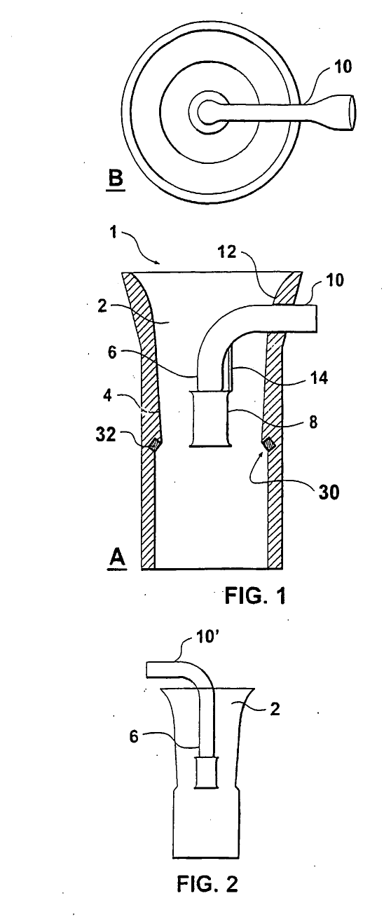

FIG. 1A and FIG. 1B are schematic diagrams of a fluid mixing venturi according to an embodiment of the present invention. The fluid mixing venturi generally indicated by arrow 1 comprises; a venturi barrel 2, a constriction region 4 inside the venturi barrel 2, a fluid outlet nozzle 6 located at a central region in the venturi barrel 2 for discharging a fluid into a fluid flowing through the venturi barrel 2, and a booster tube 8 located so as to surround a fluid flowing from the nozzle 6.

The nozzle 6 is located in the venturi barrel 2 by a fuel supply tube 10 (nozzle location device) for supplying fuel to the nozzle 6, which is mounted so as to extend out from a side wall 12 of the venturi barrel 2 and bent so as to extend downwards at the nozzle 6 end. As can be seen from FIG. 1B, the fuel supply tube 10 at a section where this is transverse to the flow in the venturi barrel 2, is formed in a streamlined oval shape in cross-section (sides squashed inwards), with a major axis aligned with the direction of flow.

FIG. 2 shows an alternative arrangement for locating the nozzle 6. In this case a fuel supply tube 10′ (also serving as a nozzle location device) is taken up and over the entry to the venturi barrel 2 rather than through the side wall 12 of the venturi barrel 2 so that the fuel supply tube 10′ is mounted so as to extend downward from the inlet to the venturi barrel 2 (coaxial with the barrel). This avoids having the fuel supply tube 10 extending across the flow of the venturi barrel 2, and impairing flow conditions. This configuration however is dependent on space available.

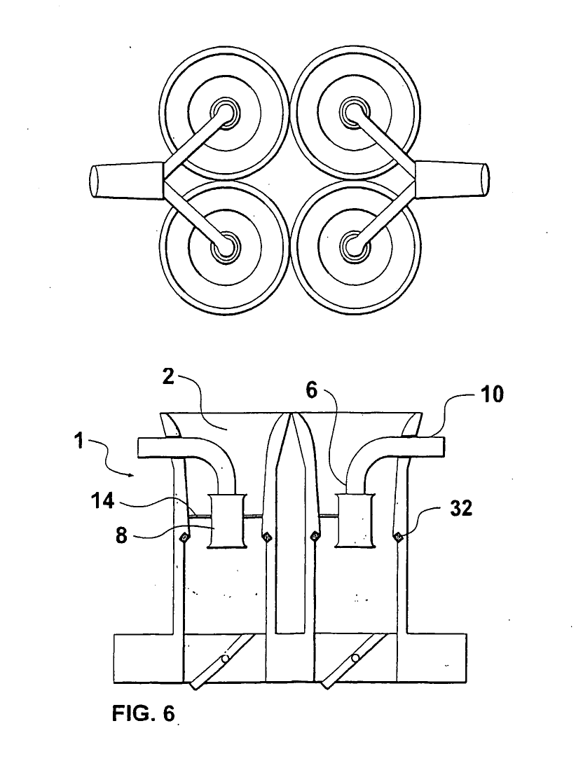

The booster tube 8 is located so as to surround the fluid flowing from the nozzle 6, by a leg 14 connected to a portion of the fuel supply tube 10. With the arrangement in FIG. 1, the leg 14 is aligned with the flow and hence causes minimum disturbance to the flow. Depending on design however, one or more legs may be connected between the booster tube 8 and the wall of the venturi barrel 2 (refer to FIG. 6). In this case the leg or legs would preferably be formed in streamlined (for example oval or rectangular) shape in cross-section, with the major axis aligned with the direction of flow, to reduce restriction to the flow.

In the embodiment of FIG. 1, the venturi barrel 2 is of cylindrical shape, and the nozzle 6 is provided substantially at the center thereof, and the booster tube 8 is of an annular shape and is positioned coaxial with the venturi barrel 2 in the vicinity of the nozzle 6 so as to surround fluid flowing therefrom. This is envisioned to be the most suitable shape and location for the components. However the invention is not to be limited as such, and other shapes and locations may be found to be suitable. For example the booster tube 8 may be square in shape. Moreover, the nozzle 6 and booster tube 8 may be located eccentrically in the venturi barrel 2.

In the embodiment of FIG. 1, the booster tube 8 is located downstream of the nozzle 6 outlet so as to only surround the fluid flowing therefrom. However, other positions of the booster tube 8 may be suitable. For example the booster tube 8 may be located higher in the venturi barrel 2, so that at least a part thereof surrounds the nozzle 6 outlet and a part surrounds the fluid flowing therefrom.

In practice, the location of the booster tube 8 in relation to the nozzle 6 would be determined by experiment to give the desired performance. For example, maximum signal with minimum restriction to flow.

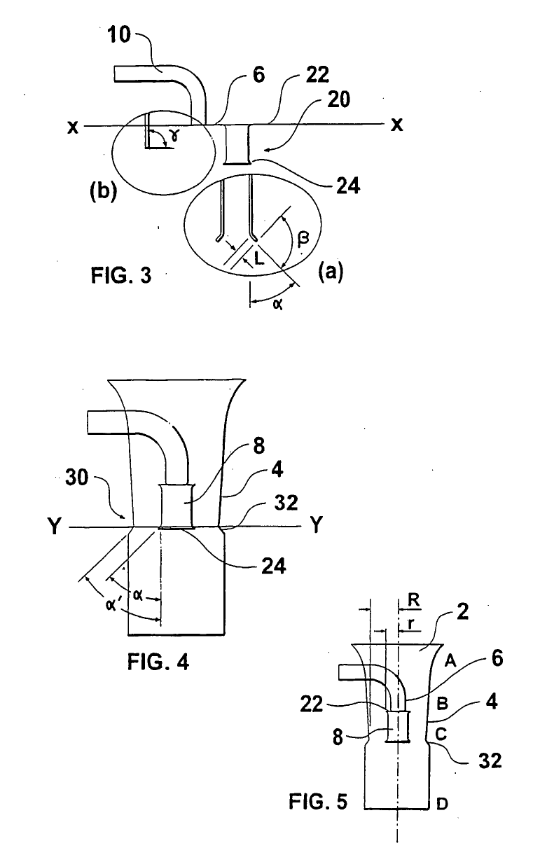

FIG. 3 shows details of a flow deflection device 20 provided on an inlet rim 22 and outlet rim 24 of the booster tube 8, for improving mixing performance, and a configuration of the nozzle 6 outlet. In FIG. 3, for purpose of explanation, the nozzle 6 is shown displaced to the left of the booster tube 8. Moreover FIG. 3(a) and (b) show enlarged views of the booster tube outlet and the nozzle outlet respectively. In this configuration the flow deflection device 20 is formed by flaring the inlet rim 22 and the outlet rim 24 outwards. Other configurations may involve forming a chamfer on the inside of either or both rims.

Referring to FIG. 3(a), typical values for the angle α of the flare to the axial direction are 30 to 50 degrees, and for the angle β of the end of the flare to the plane of the flare is 90 degrees. Moreover, a length L of the flared section is typically 2 to 3 mm in the case of a 34 mm diameter booster tube 8 inside a 55 mm diameter venturi bore 2. This length L may be determined depending on requirements (type of liquid or gas being used). Of course other values for α, β and L, are also possible, the optimum values being determined by experiment or computation.

Moreover as shown in detail in FIG. 3(b), a typical angle γ for the end face of the nozzle 6 to the axial direction is 90 degrees, and the inlet rim 22 of the booster tube 6 is typically positioned flush with the nozzle 6 outlet on line X-X (and in practice, with the booster tube 6 and nozzle 6 coaxial). Of course other locations are possible, and may be determined by experiment.

FIG. 4 (and FIG. 1) shows details of a flow deflector 30 formed in the venturi barrel 2 downstream of the constriction section 4. In this embodiment, the flow deflector 30 comprises a recessed step 32 in the wall of the venturi barrel 2 downstream of the constriction section 4.

By providing the step 32 downstream of the constriction section 4, a turbulent flow can be produced to enhance fluid mixing. Moreover, this may serve to locate a transition region of the flow, thus stabilizing the flow and ensuring more accurate positional relationship between components and flow conditions.

As shown in FIG. 4, the step 32 is formed at a similar angle α′ to the flare angle α of the outlet flow deflection device 20 formed on the booster tube 8. Moreover, the booster tube 8 is positioned in the venturi barrel 2 with the outlet rim 24 in a plane Y-Y containing the step 32. As such an annular outwardly expanding flow path is produced. From initial tests, this configuration has been found to give good signal to flow ratio, particularly with the outlet rim 24 slightly below the plane Y-Y. Of course other shapes, angles, sizes and locations for the step 32 and the outlet rim 24 may be suitable.

FIG. 5 shows a relation between the diameter of the booster tube 8 and the diameter of the venturi barrel 2 at different axial locations.

For a fluid mixing venturi for an LPG IC engine with a venturi barrel of 55 mm, a ratio of the radius r of the booster tube 8 to the radius R of the venturi barrel 2 within a range from 0.50 to 0.65, gives good performance over a wide range of operating conditions.

In operation of the fluid mixing venturi 1 according to the invention as described above, referring to FIG. 5, air flows into the venturi barrel 2 at A, due to intake suction. Then the inlet rim 22 of the booster tube 8, being tapered (flared or chamfered), captures the airflow travelling through the venturi barrel 2 and directs the air past the nozzle 6 at B, creating a depression (signal).

Moreover, the air flowing through the venturi barrel 2 between the venturi wall constriction section 4 and the booster tube 8, is sped up as the venturi barrel diameter is reduced at C and hence the pressure drops. Then when the venturi diameter rapidly increases in diameter at C due to the step 32, which is at the same point as the lower edge of the booster tube 8, due to deflection by the flow deflector 30 creating an outwardly expanding flow path, an additional depression (signal) is created, increasing again the air speed through the center of the booster tube 8, and multiplying the depression signal at the nozzle 6.

This multiplying of depression (signal) with air speed keeps the airflow through the venturi barrel 2 as high as possible (least restriction), while achieving maximum signal at the nozzle 6 (fuel supply tube).

FIG. 6 shows another possible application of the fluid mixing venturi 1 of the invention used in a four barrel carburetor. In the figure, parts having the same function as in the previous embodiment are denoted by the sae reference numerals and description thereof is omitted.

While not specifically mentioned in the above, it will be understood by those skilled in the art that the fluid mixing venturi of the invention can be used not only as a fluid mixing venturi for an LPG or CNG internal combustion engine, but can also be used for mixing gasoline for a carburetor of a gasoline engine. Moreover the fluid mixing venturi may be fitted to the intake of a fuel injection engine, for mixing CNG or LPG to give a dual fuel engine. Furthermore, the invention may find application in various other situations where mixing of fluids, both liquid or gaseous, is required.

In this respect, other applications may include fire fighting where a flame retardant is mixed into a water flow, agricultural or cleaning spray devices where a chemical is mixed with a main fluid flow, or in fluidic systems (flow regulators etc.) where good signal to flow ratio is desired for control or the like.

The above and similar designs have been used with a booster tube as small as 2 mm in a flow regulator application, and up to 80 mm diameter in an LPG engine fuel supply application, with various sizes of venturi barrels.

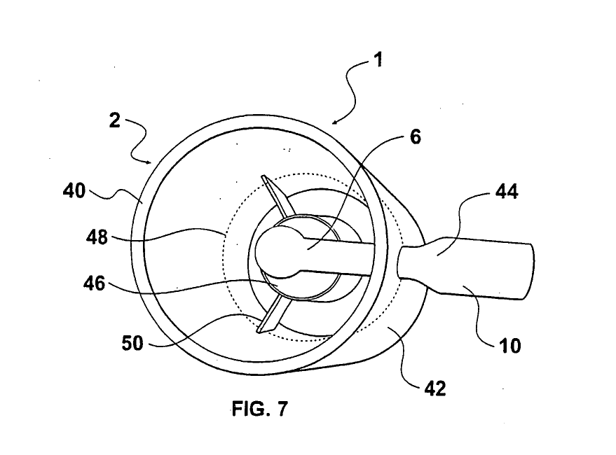

FIG. 7 is a perspective view of a fluid mixing venturi of an embodiment of the present invention illustrating a method of manufacture. In the figure, parts having the same function as in the previous embodiments are denoted by the same reference numerals and description thereof is omitted.

In this embodiment, the construction involves extrusion moulding from plastics an upper section 40 and a lower section 42 for the venturi barrel 2, a fluid supply assembly 44 including the nozzle 6, and a booster tube assembly 46 including a booster tube and a booster tube location device. These four components 40, 42, 44, and 46 are then fitted together and welded around a separation line 48 to make up the complete assembly 1.

As shown in the figure, the booster tube location device extends outwards from the booster tube as three radial spokes 50 (only two visible), and the upper and lower sections 40 and 42 are separated at the separation line 48 which is suitable positioned to enable fitting of the booster tube assembly 46 therebetween. While not clear in the figure, three cut outs are provided in the wall of the lower section 42 in the vicinity of the separation line 48 to take the spokes 50. Moreover a cutout is provided in the wall of the upper section 40 in the vicinity of the separation line 48, to take the fuel supply tube 10 of the fluid supply assembly 44.

With such an arrangement, the four components 40, 42, 44, and 46 can be manufactured separately, thus enabling low cost manufacture. Moreover since, for example, different upper and lower section 40 and 42 can be used for the same booster tube assembly 46 and/or fluid supply assembly 44, a versatile design is possible.

For example the fluid mixing venturi 1 can be easily configured to suit installation in a variety of IC engines with different size intake pipes, by selecting a suitable diameter lower section to suit the intake pipe, and a suitable diameter upper section to suit connection to an air filter of the like, while still using the same size fluid supply assembly 44, and booster tube assembly 46.

Moreover, by having separate components, the design can be easily designed for injection moulding of the components, without involving complicated moulding techniques. In this respect, it may be preferable to form the booster tube 8 with the flow deflector at the inlet rim 22 as an inwards chamfer to enable easy removal from the mold.

In assembling such a fluid mixing venturi, for example the fluid supply assembly 44 is fitted to the upper section 40, and the booster tube assembly 46 is fitted to the upper or lower sections 40 or 42. The upper and lower sections 40 and 42 are then fitted together at the separation line 48 and welded (for example high frequency welded) to make up a complete assembly 1.

Tests

The tests below compare the flow and signal rates between a factory dedicated LPG Ford Falcon™ throttle body (annular venturi) and the fluid mixing venturi of the present invention.

The tests were conducted on a flow bench, the air flow and signal numbers given below being units of measurement taken from the manometer readings. The venturi diameters were approximately the same, that for the Ford Falcon™ throttle body being 40 mm, and that for the fluid mixing venturi of the present invention being 39 mm.

Test 1

In Test 1, the relative levels of signal generated with the same air flow and similar orifice size were compared. The results are shown in Table 1 below. This demonstrates the larger signal generated by the fluid mixing venturi.

TABLE 1

| | |
|---|---|
| Falcon ™ standard | Fluid mixing venturi |

| Flow | Signal | Flow | Signal |
|---|---|---|---|
| 0.00 | 0.00 | 0.00 | 0.00 |
| 10.00 | 20.00 | 10.00 | 30.00 |
| 20.00 | 40.00 | 20.00 | 60.00 |
| 30.00 | 60.00 | 30.00 | 90.00 |
| 40.00 | 80.00 | 40.00 | 120.00 |
| 50.00 | 100.00 | 50.00 | 150.00 |
| 60.00 | 120.00 | 60.00 | 180.00 |
| 70.00 | 140.00 | 70.00 | 210.00 |
| 80.00 | 160.00 | 80.00 | 240.00 |

Test 2

Test 2 demonstrates a practical application for the fluid mixing venturi of the invention. When the signal values were matched to allow the regulator to function in its normal mode, the result was an increase in air flow when using the fluid mixing venturi.

TABLE 2

| | Falcon ™ standard | Fluid mixing venturi |
|---|---|---|
| Signal | Flow | Flow |
| 0.00 | 0.00 | 0.00 |
| 20.00 | 10.00 | 17.78 |
| 40.00 | 20.00 | 35.56 |
| 60.00 | 30.00 | 53.33 |
| 80.00 | 40.00 | 71.11 |
| 100.00 | 50.00 | 88.89 |
| 120.00 | 60.00 | 106.67 |
| 140.00 | 70.00 | 124.44 |
| 160.00 | 80.00 | 142.22 |

### INDUSTRIAL APPLICABILITY

I believe the advantages of my invention to be as follows, however it should be appreciated that all such advantages may not be realised on all embodiments of the invention and the following list is given by way of example only as being indicative of potential advantages of the present invention. Furthermore it is not intended that the advantages of the present invention be restricted to those of the list which follows:

1. By providing the booster tube in the vicinity of the fluid outlet nozzle, a good signal (pressure reduction) to flow ratio can be obtained at the nozzle, thus enabling good responsiveness to throttle opening in the case of an IC engine application (tighter tuning control).

2, By achieving a good pressure reduction at the nozzle outlet, fluid mixing (atomization) is improved so that more of the fuel is combusted and less fuel is wasted, and emissions are improved.

3. By providing the flow deflector 30 downstream of the constriction section 4, a turbulent flow can be produced to enhance fluid mixing, and this also serves to stabilize the flow and ensure more accurate positional relationship between components and flow conditions.

In view of the above advantages, it can be seen that the invention has considerably industrial applicability.

Aspects of the present invention have been described by way of example only and it should be appreciated that modifications and additions may be made thereto without departing from the scope of the invention as defined by the appended claims.

1. A fluid mixing venturi comprising;
a venturi barrel,
a constriction region inside said venturi barrel,
a fluid outlet nozzle located by nozzle location means at a central region in said venturi barrel for discharging a fluid into a fluid flowing through said venturi barrel, and
a booster tube having an inlet rim and an outlet rim and located by booster tube location means so as to surround a fluid flowing from said nozzle.

2. A fluid mixing venturi according to claim 1, wherein said venturi barrel is of cylindrical shape, and said fluid outlet nozzle is provided substantially at the center thereof, and said booster tube is of an annular shape and is positioned coaxial with said venturi barrel in the vicinity of said nozzle so as to surround fluid flowing therefrom.

3. A fluid mixing venturi according to claim 2, wherein said venturi barrel is formed with flow deflection means comprising a recessed step in a wall of said venturi barrel downstream of said constriction.

4. A fluid mixing venturi according to claim 3, wherein said outlet rim of said booster tube is formed with outlet flow deflection means formed by flaring said outlet rim outwards.

5. A fluid mixing venture according to claim 4, wherein a flare angle of said outlet flow deflection means is formed with a similar angle to said recessed step.

6. A fluid mixing venturi according to claim 3, wherein said booster tube is positioned in said venturi barrel with said outlet rim in the vicinity of a plane containing said recessed step.

7. A fluid mixing venturi according to claim 1, wherein said outlet rim of said booster tube is formed with outlet flow deflection means formed by flaring said outlet rim outwards.

8. A fluid mixing venturi according to claim 1, wherein a ratio of a radius of said booster tube to a radius of said venturi bore is within a range from 0.50 to 0.65.

9. A fluid mixing venturi according to claim 1, wherein one or more of an upper and lower section for said venturi barrel, a fluid supply assembly including said nozzle, and a booster tube assembly including said booster tube location means are molded from plastics.

10. A method of manufacturing a fluid mixing venturi according to claim 9, involving:
fitting said fluid supply assembly to said upper section,
fitting said booster tube assembly to said upper or lower section,
fitting said upper and lower sections together and
welding said upper and lower sections to make up a complete assembly.

11. A method of increasing signal and improving fluid mixing/atomization of a fluid mixing venturi comprising; a venturi barrel, a constriction region inside said venturi barrel, and a fluid outlet nozzle located by nozzle location means at a central region in said venturi barrel for discharging a fluid into a fluid flowing through said venturi barrel, said method involving: locating a booster tube so as to surround a fluid flowing from said nozzle.

12. A fluid mixing venturi according to claim 4, wherein said booster tube is positioned in said venturi barrel with said outlet rim in the vicinity of a plane containing said recessed step.

13. A fluid mixing venturi according to claim 5, wherein said booster tube is positioned in said venturi barrel with said outlet rim in the vicinity of a plane containing said recessed step.

14. A fluid mixing venturi according to claim 2, wherein said outlet rim of said booster tube is formed with outlet flow deflection means formed by flaring said outlet rim outwards.
